(19) United States
(12) Patent Application Publication
(10) Pub. No.: US 2017/0019230 A1
(43) Pub. Date: Jan. 19, 2017

(54) Communicating a Data Payload and an Acknowledgment of the Data Payload on Different Channels

(71) Applicant: QUALCOMM Incorporated, San Diego, CA (US)

(72) Inventors: Purva Rameshchandra Rajkotia, Orlando, FL (US); Lawrence Winston Yonge, III, Summerfield, FL (US); Hassan Kaywan Afkhami, San Jose, CA (US)

(21) Appl. No.: 14/797,474

(22) Filed: Jul. 13, 2015

(51) Int. Cl. H04L 5/00; H04W 52/04; H04L 12/26

(52) U.S. Cl. CPC H04L 5/0055; H04L 43/16; H04W 52/04

(57) ABSTRACT

Described herein are apparatuses, methods, and computer readable media for communicating an acknowledgment for a data payload on a network. An exemplary apparatus comprises an I/O module, and a processor coupled to the I/O module. The processor is configured to: determine a first channel for communicating the data payload, determine a second channel for communicating the acknowledgment, wherein the second channel is different from the first channel, communicate the data payload on the first channel, and communicate the acknowledgment on the second channel.

### TECHNICAL FIELD

The present application generally relates to any acknowledgment-based communication.

### BACKGROUND

There are various acknowledgment-based communication protocols. An exemplary acknowledgment-based communication protocol is Transmission Control Protocol (TCP). TCP is a transport-layer internet protocol (IP) that provides a reliable data transfer service by transmitting an acknowledgment for each data payload transmission. TCP is used for both bulk data transfer and interactive data applications. In any acknowledgment-based communication, an acknowledgment transmitted in the same channel as a data payload represents significant overhead on the channel. There is a need for more efficient acknowledgment-based communication such that the overhead on the channel is reduced.

### SUMMARY

Described herein are various embodiments of communicating an acknowledgment for a data payload on a network. In an embodiment, an apparatus is provided for communicating an acknowledgment for a data payload on a network. The apparatus comprises an I/O module and a processor coupled to the I/O module. The processor is configured to determine a first channel for communicating the data payload, determine a second channel for communicating the acknowledgment, wherein the second channel is different from the first channel, communicate the data payload on the first channel, and communicate the acknowledgment on the second channel.

In some embodiments, the data payload comprises a Transmission Control Protocol (TCP) data payload.

In some embodiments, the first channel has a higher transmission rate compared to the second channel.

In some embodiments, communicating the data payload comprises transmitting or receiving the data payload, and communicating the acknowledgment comprises transmitting or receiving the acknowledgment.

In some embodiments, the acknowledgment references a previously received data payload.

In some embodiments, the first channel is not synchronized with the second channel.

In some embodiments, the network comprises a power line communication (PAC) network.

In some embodiments, the processor is further configured to determine whether a load on the second channel is greater than or equal to a threshold level, and in response to determining the load on the second channel is greater than or equal to the threshold level, communicate the acknowledgment on the first channel, and communicate the data payload on the second channel.

In some embodiments, the processor is further configured to determine whether a communication rate on the second channel is less than a threshold level, and in response to determining the communication rate on the second channel is less than the threshold level, communicate the acknowledgment on the first channel, and communicate the data payload on the second channel.

In some embodiments, a bandwidth associated with the second channel is smaller than a bandwidth gain realized on the first channel by not communicating the acknowledgment on the first channel.

In some embodiments, a bandwidth of the second channel is selected by a user.

In some embodiments, a bandwidth of the second channel is dynamically adjusted before or during communication of the acknowledgment.

In some embodiments, the processor is further configured to communicate a bandwidth adjustment message either prior to or substantially simultaneously as communication of the acknowledgment, wherein the bandwidth adjustment message comprises information associated with a bandwidth allocated to the second channel.

In some embodiments, at least a portion of the second channel is reserved for a guard band.

In some embodiments, communication of the acknowledgment is repeated at least two times on the second channel if a transmission rate of the second channel is less than a threshold level.

In some embodiments, a method is provided for communicating an acknowledgment for a data payload on a network. The method comprises determining a first channel for communicating the data payload, determining a second channel for communicating the acknowledgment, wherein the second channel is different from the first channel, communicating the data payload on the first channel, and communicating the acknowledgment on the second channel.

In some embodiments, a computer readable medium is provided for communicating an acknowledgment for a data payload on a network. The computer readable medium comprises computer executable code configured to perform determining a first channel for communicating the data payload, determining a second channel for communicating the acknowledgment, wherein the second channel is different from the first channel, communicating the data payload on the first channel, and communicating the acknowledgment on the second channel.

In some embodiments, another apparatus is provided for communicating an acknowledgment for a data payload on a network. The apparatus comprises means for determining a first channel for communicating the data payload, means for determining a second channel for communicating the acknowledgment, wherein the second channel is different from the first channel, means for communicating the data payload on the first channel, and means for communicating the acknowledgment on the second channel.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 shows a block diagram illustrating a system for communicating between nodes on a network;

FIG. 2 shows a block diagram illustrating a communication system for communicating over a network;

FIG. 3 shows a method for establishing communication between two hosts on a network;

FIG. 4 shows a 4-byte sliding window which can be used for flow control in an acknowledgment-based data payload transmission; and

FIG. 5 shows a method for communicating an acknowledgment for a data payload on a network.

Although similar reference numbers may be used to refer to similar elements for convenience, it can be appreciated that each of the various example embodiments may be considered distinct variations.

### DETAILED DESCRIPTION

Embodiments of this disclosure may be described with respect to TCP. However, TCP is merely an exemplary protocol, and embodiments of this disclosure apply to any other types of communication protocol (e.g., acknowledgment-based communication protocol). Embodiments of this disclosure are not limited to any particular communication layer. The communication layer may be a physical (PHY) layer, a data link layer (e.g., comprising a media access control (MAC) layer), a network layer, a transport layer, a session layer, a presentation layer, or an application layer. For example, acknowledgments for TCP communication may be transmitted in both the physical and data link layers. As a further example, acknowledgments for User Datagram Protocol (UDP) communication may be transmitted in the physical layer, with no acknowledgments being transmitted in other layers. This disclosure applies equally to all types of protocol, and is not limited to transmitting acknowledgments in any particular communication layer.

An acknowledgment transmitted on the same channel as a data payload represents significant overhead on the channel. For example, suppose a data payload transmission from a transmitter to a receiver is about 1 ms in length. If this transmission is to be immediately acknowledged by the receiver, the following overhead is incurred: time for the receiver to switch from reception mode to transmission mode (to transmit an acknowledgment), time on the channel (e.g., a channel wire) for the acknowledgment to be transmitted from the receiver to the transmitter, time for the transmitter to switch from reception mode to transmission mode (to continue with the next data payload transmission). The total time for the transmission of an acknowledgment may be on the order of about 0.4 ms. Thus, in this example, the overhead for transmitting the acknowledgment is about 0.4 ms/(1+0.4)ms=28.6%. On some channels, the data payload transmission may be short (e.g., less than about 1 ms) due to higher transmission rates of the channels, but the overhead for the acknowledgment transmission is fixed because the acknowledgment transmission rate is a fixed rate. Therefore, in some channels, the overhead for acknowledgment transmission may be in excess of about 50%. Transmission efficiency refers to a transmission duration of a data payload divided by a sum of the transmission duration of the data payload and a transmission duration of overhead associated with the data payload (e.g., an acknowledgment of the data payload). Both the data payload and the acknowledgment are transmitted in an acknowledgment-based communication protocol window. Efficiency is also lost due to the acknowledgment-based communication protocol window size limiting the amount of data payload that can be transmitted in the window, further increasing the duration of the overhead items just mentioned relative to the data payload duration. The overhead items described above comprise time domain overhead.

In some embodiments, this disclosure is directed to an efficient acknowledgment-based connection, and in particular, to replacing time domain overhead associated with acknowledgment transmission with a smaller frequency domain overhead by separating out a frequency band to be used for acknowledgment transmission. A power line communication (PAC) network is an exemplary network for implementing this disclosure. However, other networks may also be used for implementing this disclosure. TCP is an exemplary protocol for implementing this disclosure. Other protocols (e.g., UDP) may also be used for implementing this disclosure.

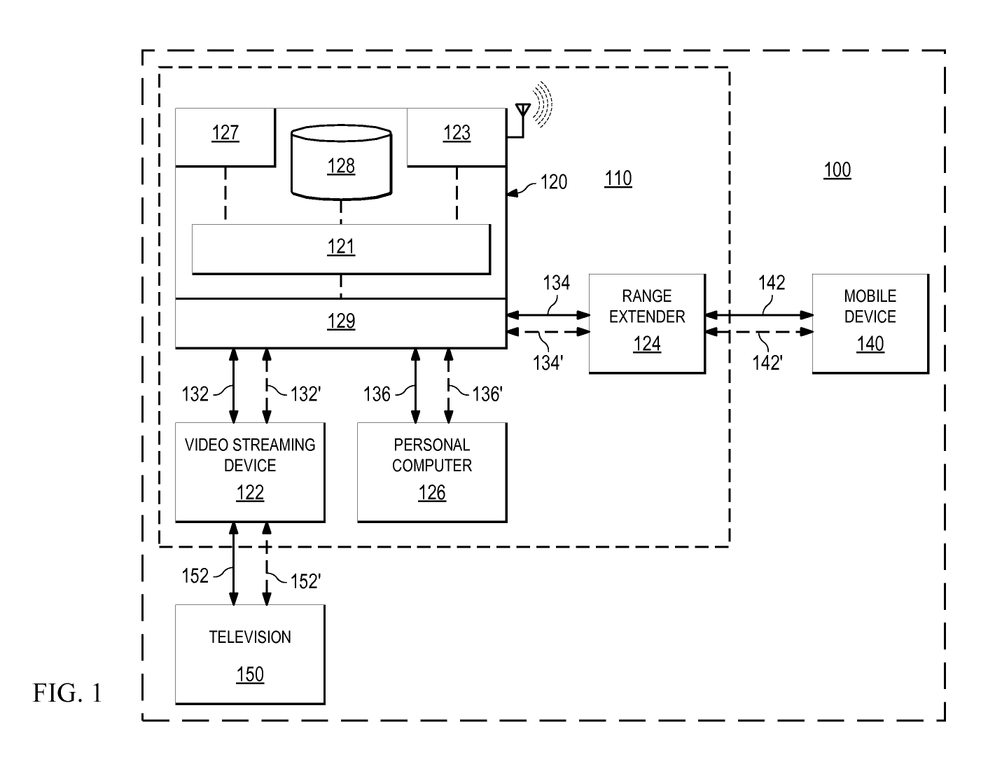

FIG. 1 shows a block diagram illustrating a system 100 for communicating between nodes on a network. As used herein, a node may represent any of the devices or device components or modules shown in FIG. 1, including, but not limited to, an access point 120, a range extender 124, a video streaming device 122, a personal computer 126, a television 150, and a mobile device 140. The system 100 includes a power line communication (PAC) network that may be deployed in a home, work place, automobile, or other environments having a power line infrastructure. The system 100 may comprise the access point 120 that receives connectivity to an external network (e.g., the internet) via a port 127. The connectivity to the external network may be established via a wired connection or a wireless connection, which may use a cellular protocol such as a 2G, 3G, or 4G LTE protocol. The access point 120 may, for example, be an internet gateway router that may comprise a wireless transceiver 123 to provide wireless connectivity (e.g., Wi-Fi) to local devices in addition to the PAC connectivity described below. The access point 120 may additionally or alternatively comprise a wired transceiver (not shown) to provide wired connectivity (e.g., Ethernet) to local devices. In some embodiments, the access point 120 may utilize HomePlug® Access Broadband Power Line (BPL) protocols for coupling to a broadband backhaul network using the wiring of a public power line infrastructure. Storage 128 may store computer executable instructions associated with any of the elements of FIG. 1.

The access point 120 may have a PAC modem 129 that enables the access point 120 to transmit and receive messages over a plurality of PAC channels 132, 136, 134, forming a PAC network 110. The PAC network 110 may utilize an existing power line infrastructure, and communications within the PAC network 110 may be implemented using a PAC protocol such as the HomePlug® 1.0, HomePlug® AV2, or the HomePlug® Green PHY protocols.

The access point 120 may communicate with the video streaming device 122 via the PAC channel 132. The video streaming device 122 may deliver video data to the television 150 via a wired PAC or non-PAC channel 152, or wireless non-PAC channel 152. The access point 120 may further communicate with the range extender 124 via a PAC channel 134 or wireless non-PAC channel. The range extender 124 may serve to extend the range of the home network provided, at least in part, by the access point 120. For example, if the access point 120 provides a Wi-Fi network having a limited range, the range extender 124 could be established at a location to extend the range of Wi-Fi connectivity. Alternatively, the range extender 124 could provide wired connectivity at a separate location from the access point 120. As shown in FIG. 1, the range extender 124 may provide a connection 142 (e.g., Wi-Fi) to a mobile device 140. The range extender 124 may effectively act as a bridge between the PAC network 110 and another network (e.g., Wi-Fi network).

The access point 120 may further communicate with a personal computer 126 via the PAC channel 136. The computer 126 may comprise or be connected to its own PAC modem that sends and receives signals on the PAC channel 136. The computer 126 may be used for a variety of applications that utilize local and/or internet connectivity including gaming, media sharing, and internet browsing. A network coordination processor 121 may implement a control strategy associated with the PAC network 110.

The various channels described with respect to FIG. 1 may have multiple carriers having corresponding frequencies. A channel carries one or more bits of information or data between a transmitting device (e.g., access point 120) and a receiving device (e.g., personal computer 126). Transmitting devices and receiving devices on a network negotiate which carriers may be used to carry information (e.g., data payloads) and the bitrate for each carrier. This information may be codified in a tone map that is sent from the transmitting device to the receiving device prior to a data payload transmission from the transmitting device to the receiving device. The transmitting or receiving device may select, either singly or in combination with each other, the carrier-specific bitrates (e.g., the values conveyed in the tone map) based on estimated signal-to-noise ratios (SNR) for each carrier. If a carrier has an SNR that is insufficient for sending even a single bit, as is possible through Binary Phase Shift Keying (BPSK), the transmitting or receiving device may determine not to use that carrier (e.g., by setting the carrier's bitrate value to 0 in the tone map).

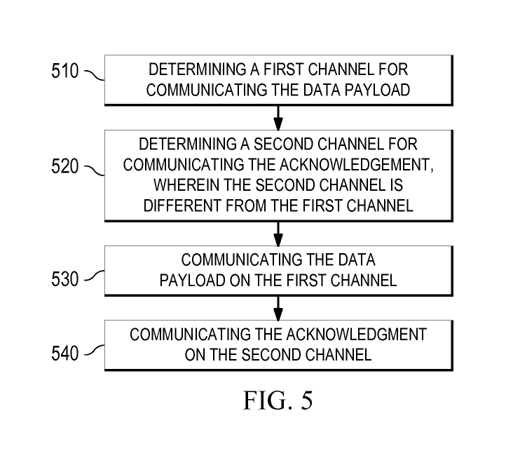

The various connections or channels 132, 134, 136, 142, and 152 may comprise first channels (for communicating data payloads and occasionally communicating acknowledgments) with respect to the method described in FIG. 5. The various connections or channels 132′, 134′, 136′, 142′, and 152′ may comprise second channels (for communicating acknowledgments) with respect to the method described in FIG. 5.

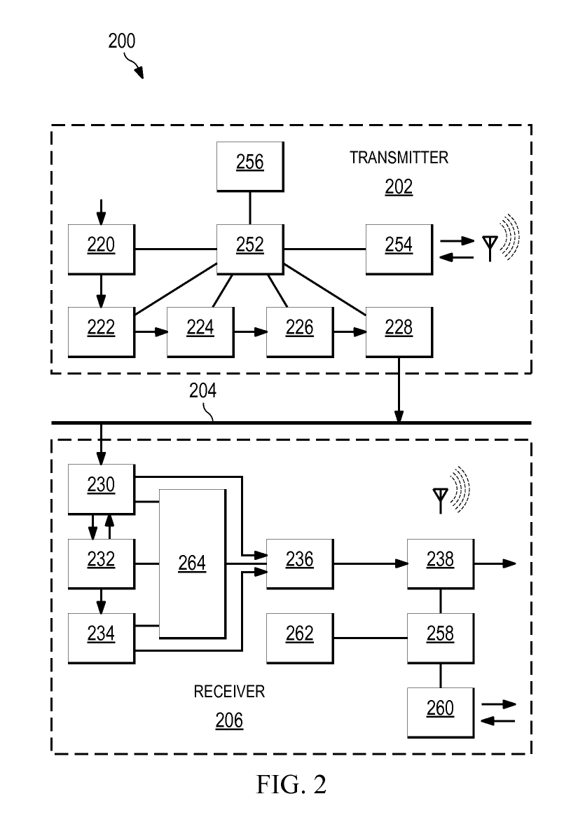

FIG. 2 shows a block diagram illustrating a communication system 200 for communicating over a network. Within the communication system 200, a transmitting device or transmitter 202 may transmit a signal (e.g., a sequence of orthogonal frequency-division multiplexing (OFDM) symbols) over a communication medium 204 to a receiving device or receiver 206. A symbol (e.g., an OFDM symbol) may include one or more bits. The transmitting device 202 and receiving device 206 may both be incorporated into any of the nodes of a network (e.g., a PAC network 110 of FIG. 1). In some embodiments, each of the nodes of the network may incorporate both the transmitting device 202 and the receiving device 206 such that each node can both transmit and receive data packets. The transmitting device 202 and the receiving device 206 may be used to communicate at least one of a data payload or an acknowledgment for the data payload, as described herein. The communication medium 204 may represent a path or channel from one node to another (e.g., over the power line infrastructure). The communication system 200 and elements of the communication system 200 are for exemplary purposes only.

At the transmitting device 202, modules implementing the physical layer receive a MAC protocol data unit (MPDU) from the MAC layer. The MAC protocol data unit is sent to an encoder module 220 to perform processing of the MPDU such as scrambling, error correction coding, and interleaving.

The encoded data is fed into a mapping module 222 that takes groups of data bits (e.g., 1, 2, 3, 4, 6, 8, or 10 bits), depending on the constellation used for the current symbol (e.g., a BPSK, QPSK, 8-QAM, 16-QAM constellation), and maps the data value represented by those bits onto the corresponding amplitudes of in-phase (I) and quadrature-phase (Q) components of a carrier waveform of the current symbol. This results in each data value being associated with a corresponding complex number Cᵢ=Aᵢ exp(jΦᵢ) whose real part corresponds to the in-phase component and whose imaginary part corresponds to the quadrature-phase component of a carrier with a peak frequency, fᵢ. Alternatively, any appropriate modulation scheme that associates data values to modulated carrier waveforms may be used.

The mapping module 222 also determines which of the carrier frequencies f₁, f₂, f₃, . . . , f_{N} within the OFDM bandwidth are used by the system 200 to transmit information. For example, some carriers that are experiencing fades can be avoided, and no information is transmitted on those carriers. Instead, the mapping module 222 uses coherent BPSK modulated with a binary value from the Pseudo Noise (PN) sequence for that carrier. For some carriers (e.g., a carrier i=10) that correspond to restricted bands (e.g., an amateur radio band) on the medium 204 that may radiate power, substantially no energy may be transmitted on those carriers (e.g., by setting A₁₀=0). The mapping module 222 also determines the type of modulation to be used on each of the carriers (or “tones”) according to a tone map. The tone map can be a default tone map, or a customized tone map determined by the receiving device.

An inverse discrete Fourier transform (IDFT) module 224 performs the modulation of the resulting set of N complex numbers (some of which may be zero for unused carriers) determined by the mapping module 222 onto N orthogonal carrier waveforms having peak frequencies f₁, f₂, f₃, . . . , f_{N}. The modulated carriers are combined by the IDFT module 224 to form a discrete time symbol waveform S(n) (for a sampling rate f_{R}), which can be written as

$$S ( n ) = 10 {\sum }_{i = 1}^{N} {A}_{i} exp [ j ( 2 π n / N + {Φ}_{i} ) ] \qquad Eq . ( 1 )$$

Where the time index n is an integer from 1 to N, Aᵢ is the amplitude and Φᵢ , is the phase of the carrier with peak frequency fᵢ=(i/N)f_{g}, and j=√−1. In some embodiments, the discrete Fourier transform corresponds to a fast Fourier transform (FFT) in which N is a power of 2.

A processing module 226 combines a sequence of consecutive (potentially overlapping) symbols into a symbol set that can be transmitted as a continuous block over the communication medium 204. The processing module 226 prepends a preamble to the symbol set that can be used for automatic gain control (AGC) and symbol timing synchronization. To mitigate intersymbol and intercarrier interference (e.g., due to imperfections in the system 200 and/or the communication medium 204), the processing module 226 can extend each symbol with a cyclic prefix that is a copy of the last part of the symbol. The processing module 226 can also perform other functions such as applying a pulse shaping window to subsets of symbols within the symbol set (e.g., using a raised cosine window or other type of pulse shaping window) and overlapping the symbol subsets.

An analog front end (AFE) module 228 couples an analog signal comprising a continuous-time (e.g., low-pass filtered) version of the symbol set to the communication medium 204. The effect of the transmission of the continuous-time version of the waveform S(t) over the communication medium 204 can be represented by convolution with a function g(τ;t) representing an impulse response of transmission over the communication medium. The communication medium 204 may add noise n(t), which may be random noise and/or narrowband noise emitted by a jammer.

At the receiving device 206, modules implementing the physical layer receive a signal from the communication medium 204 and generate a MAC protocol data unit for the MAC layer. An AFE module 230 operates in conjunction with an automatic gain control (AGC) module 232 and a time synchronization module 234 to provide sampled signal data and timing information to a discrete Fourier transform (DFT) module 236.

After removing the cyclic prefix, the receiving device 206 feeds the sampled discrete-time symbols into DFT module 236 to extract the sequence of N complex numbers representing the encoded data values (by performing an N-point DFT). A demodulator/decoder module 238 maps the complex numbers onto the corresponding bit sequences and performs the appropriate decoding of the bits (including de-interleaving and descrambling).

Any of the modules of the communication system 200 including modules in the transmitting device 202 or receiving device 206 can be implemented in hardware, software, or a combination of hardware and software. Where a module is implemented, at least in part, in software, the software may be stored in a non-volatile, machine-readable medium.

While the communication medium has generally been described as a power line infrastructure, alternative embodiments may also use the phone lines or coaxial cables (e.g., inside a house) as a communication medium. In some cases, there could be variation in signal attenuation and noise characteristics between various pairs of nodes. In such cases, systems may use channel adaptation procedures that enable selection of unique physical layer encoding parameters (e.g., modulation rate and forward error correction code rate) between a given pair of nodes. This approach enables optimization of the physical data rate that can be achieved between the pair of nodes according to current channel characteristics.

In some embodiments, the channel characteristics depend on an attenuation (and distortion) of the signal as it propagates from the transmission to the receiving device. The channel characteristics may also depend on noise within the network. The combined effect of signal attenuation (and distortion) and noise may determine the channel capacity that may be achieved between a pair of nodes. Higher channel capacity allows for more data intensive applications to be supported and/or for lower noise emissions by allowing decreased transmission power. The channel characteristics may also determine quality of a channel or how reliably information is transmitted across the channel. Indicators and measures of quality may include, for example, bit error rate (BER) or symbol error rate (SER). In general, a low quality channel is prone to distorting the messages it conveys while a high quality channel preserves the integrity of the messages it conveys. In some embodiments, the quality of the channel in use between communicating entities governs the probability of the receiving device correctly receiving the message from the transmitting device.

A processor 252 may control any of the other modules and/or functions performed by the various modules in the transmitting device 202. A processor 264 or 258 may control any of the other modules and/or functions performed by the various modules in the receiving device 206. While processors 264 and 258 are shown separately, they could represent either distinct processors or a single processor. Any actions described as being taken by a processor may be taken by the processor alone or by the processor in conjunction with one or more additional components. Additionally, while only one processor may be shown in certain devices, multiple processors may be present. Thus, while instructions may be discussed as being executed by a processor, the instructions may be executed simultaneously, serially, or otherwise by one or multiple processors. A processor may be implemented as one or more CPU chips and may be a hardware device capable of executing computer instructions. The processor may execute instructions, codes, computer programs, or scripts. The instructions, codes, computer programs, or scripts may be received from an I/O module 254 or from memory 256 for the transmitting device 202, and from an I/O module 260 or from memory 262 for the receiving device 206.

As used herein, I/O module 254 or 260 may include modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. I/O modules may also include liquid crystal displays (LCDs), touch screen displays, keyboards, keypads, switches, dials, mice, track balls, voice recognizers, card readers, paper tape readers, printers, video monitors, or other well-known input/output devices.

As used herein, memory 256 or 262 may include random access memory (RAM), read only memory (ROM), or various forms of secondary storage. RAM may be used to store volatile data and/or to store instructions that may be executed by a processor. ROM may be a non-volatile memory device that may have a smaller memory capacity than the memory capacity of a secondary storage. ROM may be used to store instructions and/or data that may be read during execution of computer instructions. Access to both RAM and ROM may be faster than access to secondary storage. Secondary storage may be comprised of one or more disk drives or tape drives and may be used for non-volatile storage of data or as an over-flow data storage device if RAM is not large enough to hold all working data. Secondary storage may be used to store programs that may be loaded into RAM when such programs are selected for execution.

As used herein, networks may represent any form of communication network between connected machines and any other network elements, and may also represent a collection of machines or virtual machines operable to provide cloud computing services to users. Networks may include a public cloud or a private cloud. Networks may include routers, hubs, switches, firewalls, content switches, gateways, call controllers, and/or any other suitable components in any suitable form or arrangement. Networks may include, in whole or in part, one or more secured and/or encrypted Virtual Private Networks (VPNs) operable to couple one or more network elements together by operating or communicating over elements of a public or external communication network. A network as described herein may be a wired or wireless network.

A node may include any device with a network interface, which includes, but is not limited to, a network component, a desktop computer, a laptop, a mobile device, a television, a watch or wristband, a laptop computer, a smart screen, a tablet computer, a desktop computer, an electronic reader, a scanner, a portable media player, a mobile computing device, a mobile phone, a wearable device (e.g., wearable on a user's arm), headgear, a gaming device, or a kiosk. A node may be a virtual machine, computer, device, instance, host, or machine in a networked computing environment. As used herein, the terms node, device, system, and apparatus are substantially equivalent and may be used interchangeably.

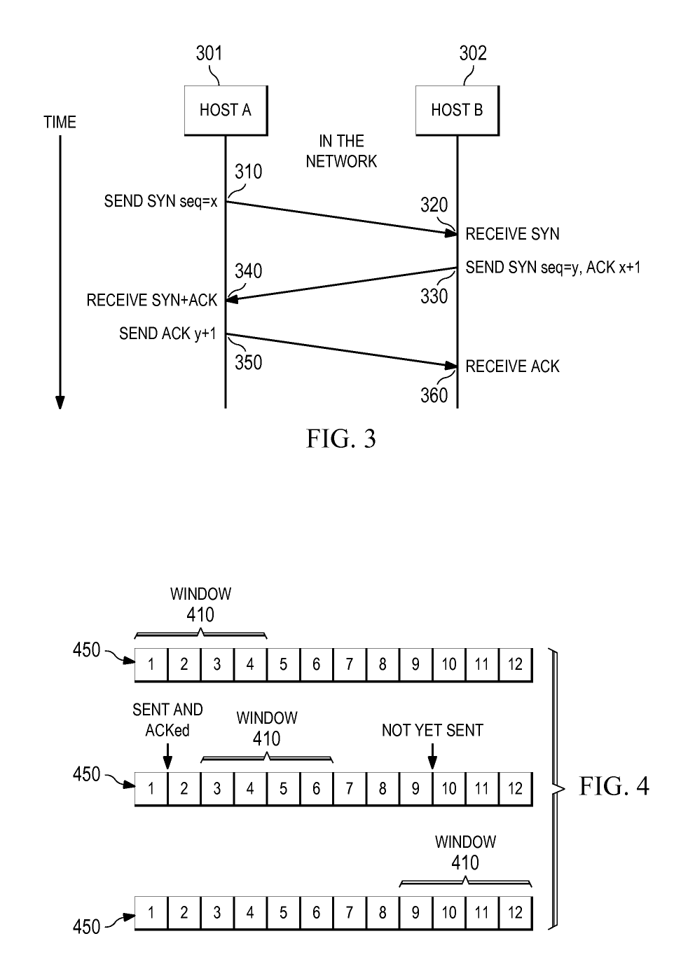

FIG. 3 shows a method for establishing communication between two hosts, Host A 301 and Host B 302. Host A 301 and Host B 302 may represent any of the nodes of FIG. 1. In order for two hosts to communicate using an acknowledgment-based communication protocol (e.g., TCP), they must first establish a connection by exchanging messages in a three-way handshake. FIG. 3 depicts the process of the three-way handshake. From FIG. 3, it can be seen that there are three acknowledgment-based communication protocol segments exchanged between two hosts, Host A 301 and Host B 302. Reading from top to bottom of FIG. 3 depicts events in time. To start, Host A 301 initiates the connection by sending 310 an acknowledgment-based communication protocol segment with a synchronization (SYN) control bit set and an initial sequence number (ISN) represented as the variable x in the sequence number field. At some moment later in time, Host B 302 receives 320 this SYN segment, processes it, and responds 330 with an acknowledgment-based communication protocol segment of its own. The response from Host B 302 includes the SYN control bit set and its own ISN represented as variable y. Host B 302 also sets the acknowledgment (ACK) control bit to indicate the next expected byte from Host A 301 should include data starting with sequence number x+1.

When Host A 301 receives 340 Host B's 302 ISN and ACK, Host A 301 finishes the connection establishment phase by sending 350 a final acknowledgment segment to Host B 302. In this case, Host A 301 sets the ACK control bit and indicates the next expected byte from Host B 302 by placing acknowledgment number y+1 as the ACK control bit. Host B 302 receives 360 the ACK from Host A 301. An exchange of source and destination ports to use for the connection are also included in each transmitter's (e.g., Host A 301 or Host B 302) segments. Thus it becomes clear that for an acknowledgment-based connection to be established between Host A 301 and Host B 302, ACK exchanges are required.

Once ISNs have been exchanged, communicating applications (e.g., an application at a transmitter communicating with an application at a receiver) may transmit data to each other. For example, the transmitter may be Host A 301, and the receiver may be Host B 302. The transmitter places acknowledgment-based communication protocol data payloads into the network channel (e.g., between the transmitter and the receiver) for a receiver to receive as long as there is data to transmit from the transmitter and as long as the transmitter does not exceed a window length advertised by the receiver. As the receiver accepts and processes acknowledgment-based communication protocol data payloads, the receiver sends back positive acknowledgments to the transmitter, indicating where in the byte stream the acknowledgments are located. These acknowledgments also include information associated with the window (e.g., the window length for data payload transmission) which determines how many bytes the receiver is currently willing to accept in each window. A receiver will continue to acknowledge the most current contiguous place in the byte stream it has accepted. Thus, as can be seen for every transmitted acknowledgment-based communication protocol data payload, there is a positive acknowledgment, which is important for reliable communication; however, this positive acknowledgment may be viewed as an overhead for acknowledgment-based communication protocol data payload transmission.

FIG. 4 shows a 4-byte sliding window 410 which can be used for flow control in an acknowledgment-based communication protocol (e.g., TCP) data payload transmission. During the data payload transmission phase, the window 410 is used to adjust the rate of flow of the byte stream 450 between communicating applications. Moving from left to right, the window 410 slides as bytes in the stream 450 are sent and acknowledged.

In some embodiments of this disclosure, an acknowledgment is transmitted on a dedicated limited-bandwidth return channel (e.g., the second channel in FIG. 5) between a transmitter and a receiver. The bandwidth of the second channel is selected such that the channel is allocated a bandwidth that is smaller than the bandwidth gain achieved by freeing the bandwidth in the prime bandwidth used for data payload transmission. In PAC, the prime bandwidth for overall transmission is about 0-30 MHz for systems compatible with the HomePlug AV specifications or about 0-86 MHz for systems compatible with the HomePlug AV2 specifications, when the transmission rate for data payload transmission is substantially optimized.

A significant advantage of using a separate second channel is the transmission of one or more acknowledgments in the second channel simultaneously with the data payload transmission comprising the acknowledgment-based communication protocol data payload in the first channel (e.g., the first channel in FIG. 5). This improves efficiency by enabling the data payload to be a larger percentage of the total data packet transmission time, wherein the data packet comprises the data payload and overhead associated with the data payload. Extra data payload can be inserted into bandwidth previously used to carry the acknowledgments and the overhead accompanying the acknowledgments. Without the second channel, no other transmission can be accommodated on the single PAC channel while the acknowledgment transmission is being executed.

The second channel may be located at frequencies that are not the most valuable frequencies for high rate (e.g., greater than or equal to a threshold rate) data payload transmission, but that support low rate (e.g., less than the threshold rate) transmission of acknowledgments. This would increase the overall data payload transmission efficiency provided that the bandwidth that is allocated for acknowledgment transmission does not exceed the overall gain of bandwidth achieved in a band that serves as the first channel. In some embodiments, the bandwidth allocation for the second channel may be user controlled or may be adjusted by the transmitter dynamically such that the bandwidth allocated for acknowledgment transmission on the second channel does not exceed the bandwidth gain realized on the first channel by not using the first channel for acknowledgment transmission. The bandwidth allocation may be transmitted by the transmitter to the receiver via a message referred to as a bandwidth adjustment message.

In some embodiments, the disclosure is directed to determining a width for the second channel. The width of this channel is optimized to satisfy the following trade off: the width is narrow enough to minimize overhead on the second channel while wide enough to support reliable acknowledgment transmission. In some embodiments, the acknowledgment transmission may be longer in duration than would be if there was no separate channel for acknowledgment transmission, which helps with improving acknowledgment transmission reliability on some poor quality channels (e.g., channels with transmission rates less than a threshold level).

As an example, a particular network supports a high quality frequency band of 25 MHz with an average transmission rate of 6 bits/sec/Hz, and a lower quality frequency band of 50 MHz with an average transmission rate of 1 bit/sec/Hz. On average, this communication system supports 25 MHz*6bits/sec/Hz+50MHz* 1bit/sec/Hz=200 Mbits/sec. If 10 MHz of the lower quality frequency band is allocated to a guard band (unused part of a spectrum between the first channel and second channel for the purpose of preventing interference between data payload transmission and acknowledgment transmission) and an acknowledgment channel, then the average rate supported would reduce to 190 Mbits/sec, resulting in an overhead of 5%. Of the 10 MHz, 2 MHz may be reserved for the guard band, and 8 MHz may be allocated for the acknowledgment channel, which would support a rate of 8 Mbit/sec. If 1 Mbit/sec is considered to be the required rate for acknowledgment transmission, then the 8 MHz acknowledgment band may provide a reliable second channel. To ensure reliability of acknowledgment transmission, the frequency allocated to the second channel should ensure an expected transmission rate substantially higher than what is required for the acknowledgment transmission. In some embodiments, the reliability of a channel may be improved by allowing time domain repetition of the acknowledgment transmission, resulting in longer duration acknowledgment transmission. This adaptation of the duration of the acknowledgment transmission may be adjusted on a link by link basis. A link is defined by two nodes on a network and a channel (e.g., a unidirectional channel) that connects one of the nodes (e.g., a transmitter of acknowledgments) to the other node (e.g., a receiver of acknowledgments).

FIG. 5 is a diagram of an embodiment of a method for communicating an acknowledgment of a data payload (e.g., a TCP or any acknowledgment-based communication protocol data payload) on a network. The first and second channels described in the method may be associated with a network such as a PLC network 110. At block 510, the method comprises determining a first channel for communicating (e.g., receiving or transmitting) the data payload. At block 520, the method comprises determining a second channel for communicating (e.g., receiving or transmitting) the acknowledgment, wherein the second channel is different from the first channel. At block 530, the method comprises communicating the data payload on the first channel. At block 540, the method comprises communicating the acknowledgment (e.g., for a previously received data payload on the first channel) on the second channel.

In some embodiments, the first channel has a higher transmission rate compared to the second channel. In some embodiments, communicating the data payload and communicating the acknowledgment are executed substantially simultaneously. In some embodiments, the first channel is not synchronized with the second channel. In other embodiments, the first channel is synchronized with the second channel.

In some embodiments, the method further comprises determining whether a load on the second channel is greater than or equal to a threshold level, and in response to determining the load on the second channel is greater than or equal to the threshold level, communicating the acknowledgment on the first channel, and communicating the data payload on the second channel. In some embodiments, the method further comprises determining whether a communication rate on the second channel is less than a threshold level, and in response to determining the communication rate on the second channel is less than the threshold level, communicating the acknowledgment on the first channel, and communicating the data payload on the second channel. Therefore, the load and/or communication rate on the first and second channels are continuously monitored such that the acknowledgment communication may be dynamically switched to the channel with the higher load and/or lower communication rate. The dynamic switching of the acknowledgment communication also results in the dynamic switching of the data payload communication to the channel with the lower load and/or higher communication rate.

In some embodiments, a bandwidth associated with the second channel is smaller than a bandwidth gain realized on the first channel by not communicating the acknowledgment on the first channel. In some embodiments, a bandwidth of the second channel is selected by a user. In some embodiments, a bandwidth of the second channel is dynamically adjusted before or during communication of the acknowledgment.

In some embodiments, the method further comprises communicating a bandwidth adjustment message either prior to or substantially simultaneously as communication of the acknowledgment. The bandwidth adjustment message comprises information associated with a bandwidth allocated to the second channel. In some embodiments, at least a portion of the second channel is reserved for a guard band. In order to ensure communication of the acknowledgment, in some embodiments, communication of the acknowledgment is repeated at least two times on the second channel, especially if a transmission rate of the second channel is less than a threshold level.

While various embodiments in accordance with the disclosed principles have been described above, it should be understood that they have been presented by way of example only, and are not limiting. Thus, the breadth and scope of the embodiments should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the embodiments set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any embodiments in this disclosure. Neither is the “Summary” to be considered as a characterization of the embodiments set forth in issued claims. Furthermore, any reference in this disclosure to “embodiment” in the singular should not be used to argue that there is only a single point of novelty in this disclosure. Multiple embodiments may be set forth according to the limitations of the multiple claims issuing from this disclosure, and such claims accordingly define the embodiments, and their equivalents, that are protected thereby. In all instances, the scope of such claims shall be considered on their own merits in light of this disclosure, but should not be constrained by the headings herein.

What is claimed is:

1. An apparatus for communicating an acknowledgment for a data payload on a network, the apparatus comprising:
an I/O module; and
a processor coupled to the I/O module, the processor configured to:
determine a first channel for communicating the data payload;
determine a second channel for communicating the acknowledgment, wherein the second channel is different from the first channel;
communicate the data payload on the first channel; and
communicate the acknowledgment on the second channel.

2. The apparatus of claim 1, wherein the data payload comprises a Transmission Control Protocol (TCP) data payload.

3. The apparatus of claim 1, wherein the first channel has a higher transmission rate compared to the second channel.

4. The apparatus of claim 1, wherein communicating the data payload comprises transmitting or receiving the data payload, and wherein communicating the acknowledgment comprises transmitting or receiving the acknowledgment.

5. The apparatus of claim 1, wherein the acknowledgment references a previously received data payload.

6. The apparatus of claim 1, wherein the first channel is not synchronized with the second channel.

7. The apparatus of claim 1, wherein the network comprises a power line communication (PLC) network.

8. The apparatus of claim 1, wherein the processor is further configured to determine whether a load on the second channel is greater than or equal to a threshold level, and in response to determining the load on the second channel is greater than or equal to the threshold level, communicate the acknowledgment on the first channel, and communicate the data payload on the second channel.

9. The apparatus of claim 1, wherein the processor is further configured to determine whether a communication rate on the second channel is less than a threshold level, and in response to determining the communication rate on the second channel is less than the threshold level, communicate the acknowledgment on the first channel, and communicate the data payload on the second channel.

10. The apparatus of claim 1, wherein a bandwidth associated with the second channel is smaller than a bandwidth gain realized on the first channel by not communicating the acknowledgment on the first channel.

11. The apparatus of claim 1, wherein a bandwidth of the second channel is selected by a user.

12. The apparatus of claim 1, wherein a bandwidth of the second channel is dynamically adjusted before or during communication of the acknowledgment.

13. The apparatus of claim 1, wherein the processor is further configured to communicate a bandwidth adjustment message either prior to or substantially simultaneously as communication of the acknowledgment, the bandwidth adjustment message comprising information associated with a bandwidth allocated to the second channel.

14. The apparatus of claim 1, wherein at least a portion of the second channel is reserved for a guard band.

15. The apparatus of claim 1, wherein communication of the acknowledgment is repeated at least two times on the second channel if a transmission rate of the second channel is less than a threshold level.

16. A method for communicating an acknowledgment for a data payload on a network, the method comprising:
determining a first channel for communicating the data payload;
determining a second channel for communicating the acknowledgment, wherein the second channel is different from the first channel;
communicating the data payload on the first channel; and
communicating the acknowledgment on the second channel.

17. The method of claim 16, wherein communicating the data payload comprises transmitting or receiving the data payload, and wherein communicating the acknowledgment comprises transmitting or receiving the acknowledgment.

18. The method of claim 16, wherein communicating the data payload and communicating the acknowledgment are executed substantially simultaneously.

19. The method of claim 16, further comprising determining whether a load on the second channel is greater than or equal to a threshold level, and in response to determining the load on the second channel is greater than or equal to the threshold level, communicating the acknowledgment on the first channel, and communicating the data payload on the second channel.

20. The method of claim 16, further comprising determining whether a communication rate on the second channel is less than a threshold level, and in response to determining the communication rate on the second channel is less than the threshold level, communicating the acknowledgment on the first channel, and communicating the data payload on the second channel.

21. The method of claim 16, wherein a bandwidth associated with the second channel is smaller than a bandwidth gain realized on the first channel by not communicating the acknowledgment on the first channel.

22. The method of claim 16, further comprising communicating a bandwidth adjustment message either prior to or substantially simultaneously as communication of the acknowledgment, the bandwidth adjustment message comprising information associated with a bandwidth allocated to the second channel.

23. A computer readable medium for communicating an acknowledgment for a data payload on a network, the computer readable medium comprising computer executable code configured to perform:
determining a first channel for communicating the data payload;
determining a second channel for communicating the acknowledgment, wherein the second channel is different from the first channel;
communicating the data payload on the first channel; and
communicating the acknowledgment on the second channel.

24. The computer readable medium of claim 23, wherein communicating the data payload comprises transmitting or receiving the data payload, and wherein communicating the acknowledgment comprises transmitting or receiving the acknowledgment.

25. The computer readable medium of claim 23, wherein the computer readable medium is further configured to determine whether a load on the second channel is greater than or equal to a threshold level, and in response to determining the load on the second channel is greater than or equal to the threshold level, communicate the acknowledgment on the first channel, and communicate the data payload on the second channel.

26. The computer readable medium of claim 23, wherein the computer readable medium is further configured to determine whether a communication rate on the second channel is less than a threshold level, and in response to determining the communication rate on the second channel is less than the threshold level, communicate the acknowledgment on the first channel, and communicate the data payload on the second channel.

27. An apparatus for communicating an acknowledgment for a data payload on a network, the apparatus comprising:
means for determining a first channel for communicating the data payload;
means for determining a second channel for communicating the acknowledgment, wherein the second channel is different from the first channel;
means for communicating the data payload on the first channel; and
means for communicating the acknowledgment on the second channel.

28. The apparatus of claim 27, wherein communicating the data payload transmitting or receiving the data payload, and wherein communicating the acknowledgment comprises transmitting or receiving the acknowledgment.

29. The apparatus of claim 27, wherein the apparatus further comprises means for determining whether a load on the second channel is greater than or equal to a threshold level, and in response to determining the load on the second channel is greater than or equal to the threshold level, means for communicating the acknowledgment on the first channel, and communicating the data payload on the second channel.

30. The apparatus of claim 27, wherein the apparatus further comprises means for determining whether a communication rate on the second channel is less than a threshold level, and in response to determining the communication rate on the second channel is less than the threshold level, means for communicating the acknowledgment on the first channel, and communicating the data payload on the second channel.
